(19) United States
(12) Patent Application Publication
(10) Pub. No.: US 2022/0168085 A1
(43) Pub. Date: Jun. 2, 2022

(54) MEDICATED AND UNMEDICATED PAW GRIPPING COMPOSITIONS, ARTICLES, APPARATUSES, AND CONSTRUCTS, AND METHODS FOR MAKING AND USING SAME

(71) Applicants: Paul Ashley, Brazoria, TX (US); Brooke Ashley, Brazoria, TX (US)

(72) Inventors: Paul Ashley, Brazoria, TX (US); Brooke Ashley, Brazoria, TX (US)

(21) Appl. No.: 17/468,365

(22) Filed: Sep. 7, 2021

Related U.S. Application Data
(60) Provisional application No. 63/074,873, filed on Sep. 4, 2020.
(60) Provisional application No. 63/087,453, filed on Oct. 5, 2020.

(51) Int. Cl. A61D 7/00; A01K 13/00

(52) U.S. Cl. CPC A61D 7/00; A01K 13/007

(57) ABSTRACT

Paw gripping compositions include one or more resins and/or one or more polymers, wherein the compositions are formulated to adhere to an animal's paws and to improve paw grip on slick surfaces, wherein the compositions may also include a carrier and/or one or more inert solids and wherein the compositions may also include one or more veterinary pharmaceutical compositions provided that the pharmaceuticals may be absorbed through the paw or through the inner paw tissue and are compatible with the paw gripping components. Paw gripping articles, apparatuses, and constructs including release sheet, an adhesive layer and at least one non-slip layer with one or more medicated layers and/or one or more shock asborbent layers interposed between the adhesive layer and the at least one non-slip layer.

### RELATED APPLICATIONS

This application claims the benefit of and priority to U.S. Provisional Patent Application Ser. Nos. 63/074,873 filed Sep. 4, 2020 and 63/087,453 file Oct. 5, 2020.

### BACKGROUND OF THE DISCLOSURE

### 1. Field of the Disclosure

Embodiments of the present disclosure relate to medicated and unmedicated paw gripping compositions, articles, apparatuses, constructs, and methods for making and using same.

In particular, embodiments of the present disclosure relate to paw gripping compositions, articles, apparatuses, constructs, and methods for making and using same, wherein the paw gripping compositions include one or more resins and/or one or more polymers, wherein the compositions are formulated to adhere to an animal's paws and to improve paw grip on slick surfaces. In certain embodiments, the compositions may also include a carrier and/or one or more inert solids. In other embodiments, the paw gripping compositions include one or more veterinary pharmaceutical compositions provided that the pharmaceuticals may be absorbed through the paw or through the inner paw tissue and are compatible with the paw gripping components. In certain embodiments, the one or more veterinary pharmaceutical compositions are absorbed onto the paw gripping components. The articles, apparatuses, and construction including release sheet layers, an adhesive layer, one or more non-slip layers, and a middle layer interposed between the adhesive layer and the non-slip layer, wherein the middle layer may include one or more medicated layers, one or more shock absorbent layers, and/or one or more thermal insulating layers.

### 2. Description of the Related Art

Animals with paw such as cats and dogs often have a hard time finding traction on slick surfaces, there is, therefore, a need in the art for compositions that improve paw traction on slick surfaces.

### SUMMARY OF THE DISCLOSURE

Embodiments of this disclosure provide paw gripping compositions include one or more resins and/or one or more polymers, wherein the compositions are formulated to adhere to an animal's paws and provide the paws with improve grip on slick surfaces. In certain embodiments, the compositions may also include a carrier and/or one or more inert solids. In other embodiments, the compositions may include one or more medications or veterinary pharmaceuticals for treating animal paws or animal diseases and/or infections provided that the medications or veterinary pharmaceutical may be absorbed through the paw, inner paw tissue, or neighboring tissues.

Embodiments of this disclosure provide unmedicated paw gripping compositions include one or more resins and/or one or more polymers. In certain embodiments, the compositions may also include a carrier and/or one or more inert solids.

Embodiments of this disclosure provide paw gripping constructs, articles, or apparatuses including four digit pads and a metacarpal pad, each of the pads including a release sheet, an adhesive layer adjacent the release sheet, at least one non-slip layer, and a middle layer interposed between the adhesive layer and the at least one non-slip layer, wherein the middle layer includes one or more shock absorption layers, one or more medicated layers, one or more thermal insulating layers or any combination thereof. In certain embodiments the pads are packaged between two packaging layers, with the pads configured on the lower packing layer with the outer non-slip layer in contact with the lower packaging layer and arranged on the low pin the conformity with a dog's paw. In other embodiments, each of the pads are separately packaged. In other embodiments, the outer non-slip layer of the pads are arranged on a weakly adhesive sheet in the configuration of a dog's paw, wherein the weakly adhesive sheet include an weakly adhesive such as a low-tack pressure-sensitive adhesive used in Post-It® Notes (registered trademark of 3M). In other embodiments, the outer non-slip layer of each of the pads are arranged on a weakly adhesive sheet for maximum sheet coverage.

Embodiments of this disclosure provide paw gripping constructs, articles, or apparatuses including either a double sided adhesive strip for affixing to digits or a metacarpal of an animal's paw and then affixing to a non-slip constructs, articles, or apparatuses or an adhesive strip having a hook and loop layer, wherein the adhesive is for affixing the strip to the digits or a metacarpal of an animal's paw and the hook and loop layer is for affixing to a non-slip constructs, articles, or apparatuses including a loop and hook layer and a non-slip layer.

Embodiments of this disclosure provide methods for making medicated paw gripping compositions including contacting one or more resins and/or one or more polymers and one or more medications or veterinary pharmaceuticals for treating animal paws or animal diseases and/or infections provided that the medications or veterinary pharmaceuticals may be absorbed through the paw, inner paw tissue, or neighboring skin tissues, wherein the methods include contacting the components under mixing conditions of time, temperature, pressure, mixing rate, and mixing type to produce homogeneous or substantially homogeneous compositions. In other embodiments, the methods include contacting one or more resins and/or one or more polymers under mixing conditions of time, temperature, pressure, mixing rate, and mixing type to form gripping compositions. The methods also include dissolving the medications or veterinary pharmaceuticals in an appropriate solvent and applying the solution to the gripping composition under mixing conditions of time, temperature, pressure, mixing rate, and mixing type and then removing the solvent by any known means such as evaporation, vacuum evaporation, distillation, lyophilization, other freeze drying techniques, spray drying, air drying, oven drying, or any other solvent removing technique now known or yet invented.

Embodiments of this disclosure provide methods for making unmedicated paw gripping methods include contacting one or more resins and/or one or more polymers under mixing conditions of time, temperature, pressure, mixing rate, and mixing type. In certain embodiments, the methods may also include adding a carrier to the composition in the contacting step.

Embodiments of the present disclosure provides methods for applying the articles, apparatuses or constructs to an animal's paw by removing the release sheet and pushing the digit pads and/or the metacarpal pad onto the animal's digits and metacarpal until the adhesive bonds to the digits and metacarpal.

### BRIEF DESCRIPTION OF THE DRAWINGS OF THE DISCLOSURE

The disclosure may be better understood with reference to the following detailed description together with the appended illustrative drawings in which like elements are numbered the same:

FIGS. 1A-C depict embodiments of containers housing the non-slip compositions of this disclosure.

FIGS. 2A-F depict embodiments of non-slip dog paw constructs, articles, or apparatuses in packaging.

FIGS. 3A-N depict embodiments of non-slip paw apparatus layered structures.

FIGS. 4A-C depict other embodiments of non-slip paw apparatus layered structures.

FIGS. 5A-C depict other embodiments of non-slip paw apparatus layered structures.

FIGS. 6A-C depict other embodiments of non-slip paw apparatus layered structures.

FIGS. 7A-D depict other embodiments of non-slip paw apparatus layered structures.

FIGS. 8A-I depict embodiments of non-slip digit outer layer structures.

FIGS. 9A-I depict other embodiments of non-slip digit outer layer structures.

FIGS. 10A-H depict embodiments of non-slip metacarpal outer layer structures.

FIGS. 11A-E depict other embodiments of non-slip pad apparatuses, constructs, or articles.

FIGS. 12A-E depict another embodiments of non-slip pad apparatuses, constructs, or articles.

FIGS. 13A-D depict another embodiments of apparatuses, constructs, or articles having a bottom surface onto which a spray on elastomeric or rubber material will adhere.

FIGS. 14A-D depict another embodiments of non-slip pad apparatuses, constructs, or articles with a battery, one or more LEDs, and none, one or more pressure sensors.

FIGS. 15A-D depict another embodiments of non-slip pad apparatuses, constructs, or articles with a battery, one or more LEDs, and none, one or more pressure sensors.

### DEFINITIONS USED IN THE DISCLOSURE

The term “at least one” means one or more or one or a plurality, additionally, these three terms may be used interchangeably within this application. For example, at least one device means one or more devices or one device and a plurality of devices.

The term “one or a plurality” means one item or a plurality of items.

The term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

The term “substantially” means that a value of a given quantity is within ±5% of the stated value. In other embodiments, the value is within ±2.5% of the stated value. In other embodiments, the value is within ±2% of the stated value. In other embodiments, the value is within ±1% of the stated value. In other embodiments, the value is within ±0.1% of the stated value.

### DETAILED DESCRIPTION OF THE DISCLOSURE

The inventors have found that compositions, articles, apparatuses, and constructs may be formulated or constructed that improve paw grip of animals with paws reducing slippage on slick surfaces.

Embodiments of the present disclosure broadly relate to medicated and unmedicated paw gripping compositions, wherein the medicated compositions include one or more resins and/or one or more polymers adapted to reduce slip and one or more medications adapted to treat animal paw diseases and/or infections or animal skin and/or paw diseases and/or infections provided that the medication may be absorbed through the paw or neighboring tissues or treat the paw or neighboring tissues and wherein the unmedicated paw gripping compositions include one or more resins and/or one or more polymers. In certain embodiments, the compositions may also include a carrier and/or one or more inert solids.

Embodiments of the present disclosure broadly relate to a container or bag having an opening and containing a medicated and unmedicated paw gripping composition, wherein the medicated composition includes one or more resins and/or one or more polymers adapted to reduce slip and one or more medications adapted to treat animal paw diseases and/or infections or animal skin and/or paw diseases and/or infections provided that the medication may be absorbed through the paw or neighboring tissues or treat the paw or neighboring tissues and wherein the unmedicated paw gripping composition includes one or more resins and/or one or more polymers. In certain embodiments, the composition may also include a carrier and/or one or more inert solids. The container or bag is designed to apply the composition to an animal's paws by placing the animal's paws in the container or bag so that the composition adhere to the animal's paws. In other embodiments, the bag is closed and is permeable of the compositions so that the composition may be shaken or dabbed onto the animal's paws.

Embodiments of the present disclosure broadly relate to methods for making medicated paw gripping compositions including contacting one or more resins and/or one or more polymers and one or more medications or veterinary pharmaceutical compositions for treating animal paws or animal diseases and infections provided that the medications or veterinary pharmaceutical compositions may be absorbed through the paw, inner paw tissue, or neighboring skin tissues, wherein the methods include contacting the components under mixing conditions of time, temperature, pressure, mixing rate, and mixing type to produce a homogeneous or substantially homogeneous composition. In other embodiments, the methods include contacting one or more resins and/or one or more polymers under mixing conditions of time, temperature, pressure, mixing rate, and mixing type to form a gripping composition. The methods also include dissolving the medications or veterinary pharmaceutical compositions in an appropriate solvent and applying the solution to the gripping composition under mixing conditions of time, temperature, pressure, mixing rate, and mixing type and then removing the solvent by any known means such as evaporation, vacuum evaporation, distillation, lyophilization, other freeze drying techniques, spray drying, air drying, oven drying, or any other solvent removing technique now known or yet invented.

Embodiments of the present disclosure broadly relate to methods for applying a composition of this invention to an animal's paw by placing the paws in contact with the composition in a container or a bag having an opening, wherein the paws are in contact with composition for a time sufficient for the paws to be coated with the compositions to improve paw grip on slick surfaces.

Embodiments of this disclosure provide paw gripping constructs, articles, or apparatuses including four digit pads and a metacarpal pad, each of the pads includes a release sheet, an adhesive layer adjacent the release sheet, at least one non-slip layer, and a middle layer interposed between the adhesive layer and the at least one non-slip layer, wherein the middle layer includes one or more shock absorption layers, one or more medicated layers, one or more thermal insulating layers or any combination thereof. In certain embodiments, the pads are packaged between two packaging layers, wherein the outer non-slip layers are in contact with the lower packaging layer and arranged in conformity with an animal's paw. In other embodiments, each of the pads are separately packaged. In other embodiments, the outer non-slip layer of the pads are arranged on a weakly adhesive sheet and arranged in conformity with an animal's paw. In other embodiments, the outer non-slip layer of each of the pads are arranged on a weakly adhesive sheet for maximum sheet coverage. For example, the metacarpal pads are arranged on a weakly adhesive sheet for maximum sheet coverage. The thermal insulating layers are designed to reduce or prevent paw damage from hot surfaces such as hot concrete, hot asphalt, hot sand, or any other hot surface that may cause damage to an animals paws.

Embodiments of the present disclosure broadly relate to methods for applying the articles, apparatuses or constructs to an animal's paw by removing the release sheet and pushing the digit pads and/or the metacarpal pad onto the animal's digits and metacarpal until the adhesive bonds to the digits and metacarpal.

### Suitable Components for Use in the Disclosure

Suitable resins for use in the compositions of this disclosure include, without limitation, tree pine rosin, resins based on abietic acid, synthetic rosins, plant resins, amber rosins, or mixtures or combinations thereof.

Suitable polymers for use in the compositions of this disclosure include, without limitation, resins based on oligomers or polymers of bisphenol A diglycidyl ether, phenolic resins, urea resins, urethane resins, other resins, or mixtures or combinations thereof.

Suitable inert solids for use in the compositions of this disclosure include, without limitation, chalk, fumed silica, talc, ground mica, magnesium carbonate, starch, eggshell, chitin, magnesium silicate, magnesium sulfate, zeolites, aluminum silicates silica aluminates, titanium dioxide, or mixtures and combinations thereof. Other additive include, without limitation, aluminum- or zirconium-chlorohydrate additive selected from the group consisting of: aluminum chloride, aluminum chloride hexahydrate, aluminum chlorohydrex polyethylene glycol, aluminum chlorohydrex propylene glycol, aluminum dichlorohydrate, aluminum dichlorohydrex polyethylene glycol, aluminum dichlorohydrex propylene glycol, aluminum sesquichlorohydrate, aluminum sesquichlorohydrex polyethylene glycol, aluminum sesquichlorohydrex propylene glycol, aluminum zirconium octachlorohydrate, aluminum zirconium octachlorohydrex gly, aluminum zirconium pentachlorohydrate, aluminum zirconium glycine, aluminum zirconium pentachlorohydrex gly, aluminum zirconium tetrachlorohydrate, aluminum zirconium tetrachlorohydrex gly, aluminum zirconium trichlorohydrate, aluminum zirconium trichlorohydrex glycine and mixtures or combinations thereof.

Suitable veterinary drugs for use with this disclosure include, without limitation, acepromazine (sedative, tranquilizer, and antiemetic), alprazolam (benzodiazepine used as an anxiolytic and tranquilizer), altrenogest (used to synchronizes estrus), amantadine (analgesic for chronic pain), aminophylline (bronchodilator), amitraz (antiparasitic used to control ticks, mites, lice and other animal pests), amitriptyline (tricyclic antidepressant used to treat separation anxiety, excessive grooming and spraying in dogs and cats), amlodipine (calcium channel blocker used to decrease blood pressure), amoxicillin (antibacterial), puniatozol (antiprotozoal drug used against coccidiosis), apomorphine (emetic (used to induce vomiting)), artificial tears (lubricant eye drops used as a tear supplement), atenolol (treats cardiac arrythmias, hypertension, and diabetes plus other cardiovascular disorders), atipamezole (α2-adrenergic antagonist used to reverse the sedative and analgesic effects of alpha-2 adrenergic receptor agonists), baytril (antibiotic), benazepril (ACE-inhibitor used in heart failure, hypertension, chronic renal failure and protein-losing nephropathy), bethanechol (stimulates bladder contractions), bupivacaine (local anesthetic primarily utilized pre- and post-operatively), buprenorphine (narcotic for pain relief in cats after surgery, butorphanol (mu agonist/kappa antagonist, used as a cough suppressant and for a muscle relaxation effect in horses), carprofen (COX-2 selective NSAID used to relieve pain and inflammation in dogs and cats), cefovecin (cephalosporin-class antibiotic used to treat skin infections in dogs and cats), cefpodoxime (antibiotic), cephalexin (antibiotic, particularly useful for susceptible Staphylococcus infections), ceftiofur (cephalosporin antibiotic), chloral hydrate/magnesium sulfate/pentobarbital (combination anesthetic agent), chloramphenicol (antibacterial used to treat anaerobic bacterial infections, both Gram-positive and -negative), cimetidine (H2 antagonist used to reduce gastric acid production), ciprofloxacin (antibiotic of quinolone group), clamoxyquine (antiparasitic to treat salmonids for infection with the myxozoan parasite, Myxobolus cerebralis), clavamox (antibiotic, used to treat skin and other infections), clavaseptin (antibiotic), clavulanic acid (adjunct to penicillin-derived antibiotics used to overcome resistance in bacteria that secrete beta-lactamase), clenbuterol (decongestant and bronchodilator used for the treatment of recurrent airway obstruction in horses), clindamycin (antibiotic with particular use in dental infections with effects against most aerobic Gram-positive cocci), clomipramine (primarily used in dogs to treat behavioral problems), cyproheptadine (used as an appetite stimulant in cats and dogs), deracoxib (nonsteroidal anti-inflammatory drug), dexamethasone (anti-inflammatory steroid), diazepam (benzodiazepine used to treat status epilepticus, also used as a preanesthetic and a sedative), dichlorophene (fungicide, germicide, and antimicrobial agent, also used for the removal of parasites), diphenhydramine (histamine blocker), doxycycline (antibiotic, also used to treat Lyme disease), enalapril (ACE-inhibitor used to treat high blood pressure and heart failure), enrofloxacin (Broad spectrum antibiotic (Gram-positive and -negative)—not recommended for streptococci, or anaerobic bacteria), equine chorionic gonadotropin (gonadotropic hormone used to induce ovulation in livestock prior to artificial insemination), fenbendazole (antiparasite drug use for mainly against nematodes), fipronil (antiparasiticide), flunixin meglumine (nonsteroidal anti-inflammatory drug used as an analgesic and antipyretic in horses), furosemide (diuretic used to prevent exercise induced pulmonary hemorrhage in horses), gabapentin (strong pain reliever), gentamicin/betamethasone valerate/clotrimazole (combination drug product used to treat ear disease in dogs), glycopyrrolate (emergency drug used for cardiac support), hydromorphone (opioid analgesic used as a premedication), hydroxyzine (antihistamine drug used primarily for treatment of allergies), isoxsuprine (vasodilator used for laminitis and navicular disease in horses), ivermectin (a broad-spectrum antiparasitic used in horses, cattle, sheep, goats and dogs), ketamine (dissociative anesthetic and tranquilizer in cats, dogs, horses, and other animals), ketoprofen (nonsteroidal anti-inflammatory drug (NSAID)), levamisole (antiparasitic), levetiracetam (anti-convulsant used for seizures), levothyroxine (used in the treatment of hypothyroidism), lufenuron (insecticide used for flea control), marbofloxacin (antibiotic), maropitant (antiemetic), mavacoxib (nonsteroidal anti-inflammatory drug (NSAID)), medetomidine (surgical anesthetic and analgesic), meloxicam (nonsteroidal anti-inflammatory drug (NSAID)), metacam (used to reduce inflammation and pain), methimazole (used in treatment of hyperthyroidism), metoclopramide (potent antiemetic, secondarily as a prokinetic), metronidazole (antibiotic against anaerobic bacteria), milbemycin oxime (broad spectrum antiparasitic used as an anthelmintic, insecticide and miticide), mirtazapine (antiemetic and appetite stimulant in cats and dogs), mitratapide (used to help weight loss in dogs), morphine (pure mu agonist/opioid analgesic used as a premedication), moxifloxacin (antibiotic), neomycin (antibacterial), nimesulide (nonsteroidal anti-inflammatory drug (NSAID)), nitarsone (feed additive used in poultry to increase weight gain, improve feed efficiency, and prevent histomoniasis (blackhead disease)), nitenpyram (insecticide), nitroscanate (anthelmintic used to treat roundworms, hookworms and tapeworms), nitroxynil (anthelmintic for fasciola and liver fluke infestations), nystatin (antifungal), oxytetracycline (antibiotic), ofloxacin (fluoroquinolone antibiotic), oclacitinib (antipruritic), omeprazole (used for treatment and prevention of gastric ulcers in horses), oxibendazole (anthelmintic), oxymorphone (analgesic), pentobarbital (humane euthanasia of animals not to be used for food), pentoxyfylline (xanthine derivative used in as an antiinflammatory drug and in the prevention of endotoxemia), pergolide (dopamine receptor agonist used for the treatment of pituitary pars intermedia dysfunction in horses), phenobarbital (antiseizure medication), phenylbutazone (nonsteroidal anti-inflammatory drug (NSAID)), phenylpropanolamine (controls urinary incontinence in dogs), phenytoin/pentobarbital (animal euthanasia product containing phenytoin and pentobarbital), pimobendan (phosphodiesterase 3 inhibitor used to manage heart failure in dogs), pirlimycin (antimicrobial), ponazuril (anticoccidial), praziquantel (treatment of infestations of the tapeworms Dipylidium caninum, Taenia pisiformis, Echinococcus granulosus), prazosin (sympatholytic used in hypertension and abnormal muscle contractions), prednisolone (glucocorticoid (steroid) used in the management of inflammation and auto-immune disease, primarily in cats), prednisone (glucocorticoid (steroid) used in the management of inflammation and auto immune disease), propofol (short acting intravenous drug used to induce anesthesia), pyrantel (effective against ascarids, hookworms and stomach worms), rafoxanide (parasiticide), rifampin (anti-microbial primarily used in conjunction with other erythromycin in the treatment of Rhodococcus equi infections in foals), robenacoxib (nonsteroidal anti-inflammatory drug (NSAID)), roxarsone (arsenical used as a coccidiostat and for increased weight gain), selamectin (antiparasitic treating fleas, roundworms, ear mites, heartworm, and hookworms), silver sulfadiazine (antibacterial), streptomycin (antibiotic used in large animals), sucralfate (treats gastric ulcers), sulfasalazine (anti-inflammatory and antirheumatic), Telazol (intravenous drug used to induce anesthesia; combination of tiletamine and zolazepam), tepoxalin (nonsteroidal anti-inflammatory drug (NSAID)), theophylline (for brochospasm and cardiogenic edema), thiostrepton (antibiotic), thiabendazole (antiparasitic), tolfenamic acid—nonsteroidal anti-inflammatory drug (NSAID)), tramadol (analgesic), triamcinolone acetonide (corticosteroid), trimethoprim—used widely for bacterial infections, is in the family of sulfa drugs), trimethoprim/sulfadoxine—antibacterial containing trimethoprim and sulfadoxine), trilostane (for canine Cushing's (hyperadrenocorticism) syndrome), tylosin (antibiotic), ursodeoxycholic acid (INN) or ursodiol (USAN)—hydrophilic bile acid used to treat liver diseases), xylazine (α2-adrenergic agonist, used to temporarily sedate animals), yohimbine (used to reverse effects of xylazine, also called an “antidote” to xylazine, or any combination thereof, provided that the drugs can be formulated to be absorbed through the paw and are compatible with the grip components.

Suitable adhesives for use here include, without limitation, any FDA approved adhesive or any veterinary approved adhesive. Exemplary examples include, without limitation, acrylates, methacrylates, epoxy diacrlates, poly ethylenically unsaturated monomers, poly dienes, polymers including mixtures of ethylenically unsaturated monomers and diene monomers, copolymers, polymers including more than two ethylenically unsaturated monomers or diene monomers, or mixtures and combinations thereof.

Suitable medicate layer carriers for use here include, without limitation, any FDA approved polymeric carrier or any veterinary approved polymeric carrier. Exemplary examples include, without limitation, hydrogels, the adhesives set forth above, or mixtures and combinations thereof.

Suitable non-slip layer materials for use here include, without limitation, any rubber composition used in tires or shoes. Exemplary examples include, without limitation, cured poly ethylenically unsaturated monomers, poly dienes, polymers including mixtures of ethylenically unsaturated monomers and dienes, copolymers, polymers including more than two ethylenically unsaturated monomers or diene monomers, or mixtures and combinations thereof, wherein the polymers may be cured by sulfur containing cure systems, by radiation, by free radical systems, or combinations thereof. Exemplary examples include, without limitation, block or random styrene-butadiene rubbers, polyisoprene rubbers, butadiene rubbers, block or random styrene-isoprene rubbers, EPDM rubbers, EP rubbers, block or random styrene-butadiene-isoprene rubbers, polyisobutylene rubbers, silicon rubbers, urethane rubbers, any other rubber, or mixtures and combinations thereof.

Suitable shock absorbent layer materials for use here include, without limitation, any shock absorbent material used in shoes. Exemplary examples include, without limitation, ethylene-vinyl acetate polymers, butyl rubbers, neoprene rubbers, sorbathanes, viscoelastic polymers, viscoelastic thermoset soy-based polymers, any other shock absorbent polymers, or mixtures or combinations thereof. Exemplary examples include, without limitation, foamed versions of any of the non-slip polymers or shock absorbent materials. Additionally, the shock absorbent layers may comprise foams of any of the afore mentioned rubbers or other elastomers.

Suitable thermal insulating materials for use here include, without limitation, any one of the tabulated polymers, or mixtures and combinations thereof.

Table of Thermal Insulating Materials

| | Min | Max |
|---|---|---|
| | Value | Value |
| Polymer Name | (W/m · K) | (W/m · K) |
| acrylonitrile butadiene styrene (ABS) | 0.130 | 0.190 |
| ABS Flame Retardant | 0.173 | 0.175 |
| ABS High Heat | 0.200 | 0.400 |
| ABS High Impact | 0.200 | 0.400 |
| ABS/polycarbonate (ABS/PC) blend 20% | 0.140 | 0.150 |
| glass fiber | | |
| acrylonitrile styrene acrylate (ASA) | 0.170 | 0.170 |
| ASA/polycarbonate (ASA/PC) blend | 0.170 | 0.170 |
| ASA/PC flame retardant | 0.170 | 0.700 |
| cellulose acetate (CA) | 0.250 | 0.250 |
| cellulose acetate butyrate (CAB) | 0.250 | 0.250 |
| cellulose proprionate (CP) | 0.190 | 0.190 |
| chlorinated polyvinyl chloride (CPVC) | 0.160 | 0.160 |
| ethylene chlorotrifluoroethylene (ECTFE) | 0.150 | 0.150 |
| ethylene vinyl alcohol (EVOH) | 0.340 | 0.360 |
| fluorinated ethylene propylene (FEP) | 0.250 | 0.250 |
| high density polyethylene (HDPE) | 0.450 | 0.500 |
| high impact polystyrene (HIPS) | 0.110 | 0.140 |
| HIPS Flame Retardant V0 | 0.120 | 0.120 |
| ethylene-methyl acrylate copolymer | 0.230 | 0.250 |
| (Ionomer) | | |
| glass fiber-reinforced (LCP) | 0.270 | 0.320 |
| low density polyethylene (LDPE) | 0.320 | 0.350 |
| linear low density polyethylene (LLDPE) | 0.350 | 0.450 |
| transparent acrylonitrile butadiene styrene | 0.170 | 0.180 |
| (MABS) | | |
| polyamide 11 (PA 11) 30% glass fiber | 0.330 | 0.330 |
| reinforced | | |
| PA 11, Conductive | 0.330 | 0.330 |
| PA 11, Flexible | 0.330 | 0.330 |
| PA 11, Rigid | 0.330 | 0.330 |
| polyamide 12 (PA 12), Flexible | 0.330 | 0.330 |
| PA 12, Rigid | 0.330 | 0.330 |
| polyamide 46 (PA 46) | 0.300 | 0.300 |
| polyamide 6 (PA 6) | 0.240 | 0.240 |
| polyamide 6-10 (PA 6-10) | 0.210 | 0.210 |
| polyamide 6-6 (PA 66) | 0.250 | 0.250 |
| PA 66 30% glass fiber | 0.280 | 0.280 |
| PA 66 30% mineral filled | 0.380 | 0.380 |
| PA 66 impact modified, 15-30% Glass Fiber | 0.300 | 0.300 |
| PA 66 impact modified | 0.240 | 0.450 |
| polyamide-imide (PAI) | 0.240 | 0.540 |
| PAI 30% glass fiber | 0.360 | 0.360 |
| PAI Low Friction | 0.520 | 0.520 |
| polyarylate (PAR) | 0.180 | 0.210 |
| polyarylamide (PARA) 30-60% glass fiber | 0.300 | 0.400 |
| polybutylene terephthalate (PBT) | 0.210 | 0.210 |
| PBT 30% glass fiber | 0.240 | 0.240 |
| polycarbonate (PC) 20-40% glass fiber | 0.220 | 0.220 |
| PC 20-40% glass fiber flame retardant | 0.210 | 0.390 |
| PC high heat | 0.210 | 0.210 |
| polyethylene (PE) 30% glass fiber | 0.300 | 0.390 |
| polyetheretherketone (PEEK) | 0.250 | 0.250 |
| PEEK 30% carbon fiber-reinforced | 0.900 | 0.950 |
| PEEK 30% glass fiber-reinforced | 0.430 | 0.430 |
| polyetherimide (PEI) | 0.220 | 0.250 |
| PEI 30% glass fiber-reinforced | 0.230 | 0.260 |
| polyetherketoneketone (PEKK) low | 1.750 | 1.750 |
| cristallinity grade | | |
| polyethersulfone (PESU) | 0.170 | 0.190 |
| polyethylene terephthalate (PET) | 0.290 | 0.290 |
| PET 30% glass fiber-reinforced | 0.330 | 0.330 |
| polyethylene terephthalate glycol (PETG) | 0.190 | 0.190 |
| perfluoroalkoxy (PFA) | 0.190 | 0.260 |
| polyimide (PI) | 0.100 | 0.350 |
| polylactide (PLA) | 0.110 | 0.195 |
| polymethylmethacrylate/acrylic (PMMA/ | 0.150 | 0.250 |
| acrylic) | | |
| PMMA/acrylic high heat | 0.120 | 0.210 |
| PMMA/acrylic impact modified | 0.200 | 0.220 |
| polyoxymethylene (POM acetal) | 0.310 | 0.370 |
| POM acetal low friction | 0.310 | 0.310 |
| polypropylene (PP) 10-20% glass fiber | 0.200 | 0.300 |
| PP 10-40% mineral filled | 0.300 | 0.400 |
| PP 10-40% talc filled | 0.300 | 0.400 |
| PP 30-40% glass fiber-reinforced | 0.300 | 0.300 |
| PP copolymer | 0.150 | 0.210 |
| PP homopolymer | 0.150 | 0.210 |
| PP impact modified | 0.150 | 0.210 |
| polyphenylene ether (PPE) | 0.160 | 0.220 |
| PPE 30% glass fiber-reinforced | 0.280 | 0.280 |
| PPE flame retardant | 0.160 | 0.220 |
| polyphenylene sulfide (PPS) | 0.290 | 0.320 |
| PPS 20-30% glass fiber-reinforced | 0.300 | 0.300 |
| PPS 40% glass fiber-reinforced | 0.300 | 0.300 |
| PPS conductive | 0.300 | 0.400 |
| PPS glass fiber & mineral-filled | 0.600 | 0.600 |
| polystyrene (PS) 30% glass fiber | 0.190 | 0.190 |
| PS crystal | 0.160 | 0.160 |
| PS high heat | 0.160 | 0.160 |
| polysulfone (PSU) | 0.120 | 0.260 |
| PSU 30% glass fiber-reinforced | 0.300 | 0.300 |
| polytetrafluoroethylene (PTFE) | 0.240 | 0.240 |
| PTFE 25% glass fiber-reinforced | 0.170 | 0.450 |
| polyvinylchloride (PVC) plasticized | 0.160 | 0.160 |
| PVC plasticized filled | 0.160 | 0.160 |
| PVC rigid | 0.160 | 0.160 |
| polyvinylidene chloride (PVDC) | 0.160 | 0.200 |
| polyvinylidene fluoride (PVDF) | 0.180 | 0.180 |
| styrene acrylonitrile (SAN) | 0.150 | 0.150 |
| SAN 20% glass fiber-reinforced | 0.200 | 0.320 |
| styrene maleic anhydride (SMA) | 0.170 | 0.170 |

Suitable batteries for use herein include, without limitation, any ultra thin battery such as the lithium polymer ion batteries, nickel-cadmium batteries, other ultra thin batteries.

Suitable light emitting diodes for use herein include, without limitation, any small or ultra small light emitting diode of the color.

### Detailed Description of the Drawings of the Disclosure

### Non-Slip Composition Containers

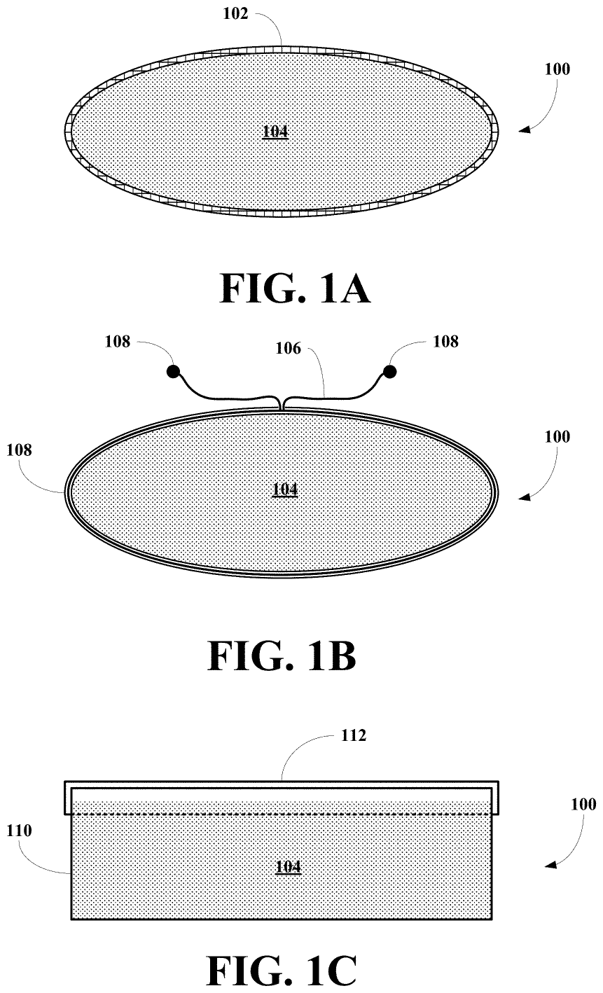

Referring now to FIGS. 1A-C, embodiments of containers for the non-slip compositions, generally 100, are shown. Looking at FIG. 1A, an embodiment of a container 100 includes a permeable outer layer 102 containing a non-slip composition 104 of this disclosure. Looking at FIG. 1B, another embodiment of a container 100 includes a draw string 106 having bead ends 108, wherein the bag 106 contains the non-slip composition 104. Looking at FIG. 1C, another embodiment of a container 100 includes a box 110 including a lid 112, wherein the box 110 contains the non-slip composition 104.

### Paw Pad Apparatuses, Constructs, and Articles

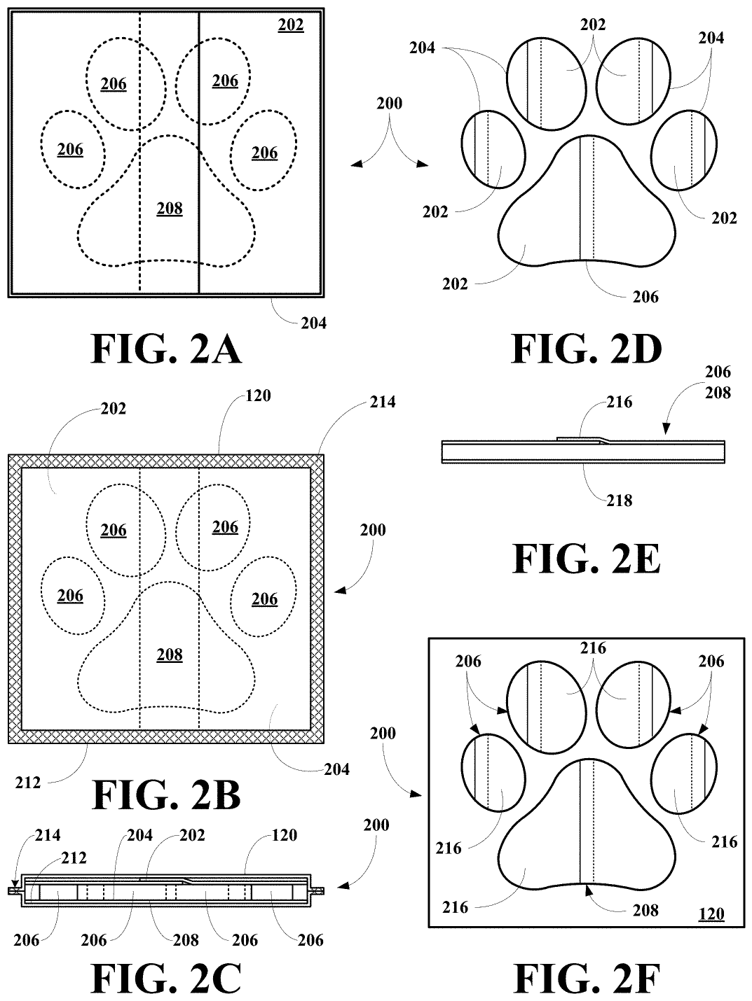

Referring now to FIGS. 2A-F, embodiments of non-slip paw constructs, articles, or apparatuses, generally 200, are shown. Looking at FIG. 2A, an embodiment of the constructs, articles, or apparatuses 200 is shown to include a top release sheet 202 and a bottom sheet 204 and four digit pad members 206 and a metacarpal pad member 208 interposed between the release sheet 202 and the bottom sheet 204. Looking at FIGS. 2B&C, another embodiment of the constructs, articles, or apparatuses 200 is shown to include a top packaging sheet 210 and a bottom packaging sheet 212 bonded together at a bonding area 214. Sandwiched between the top packaging sheet 210 and the bottom packaging sheet 212 are top release sheet 202, the bottom sheet 204, the four digit pad members 206 and the layered metacarpal pad member 208. Looking at FIGS. 2D&E, another embodiment of the constructs, articles, or apparatuses 200 is shown to include a top release sheet 216 and a bottom sheet 218 with the four digit pad members 206 and the metacarpal pad member 208 interposed therebetween. It should be recognized that the constructs, articles, or apparatuses 200 of FIGS. 2D&E may include the packaging of FIGS. 2B&C. Looking at FIG. 2F, another embodiment of the constructs, articles, or apparatuses 200 is shown to include the four digit pad members 206 and the metacarpal pad member 208 disposed on a weakly adhesive bottom sheet 220. Again, it should be recognized that the constructs, articles, or apparatuses 200 of FIG. 2F may include the packaging of FIGS. 2B&C.

### Paw Pad Apparatus, Construct, and Article Layers

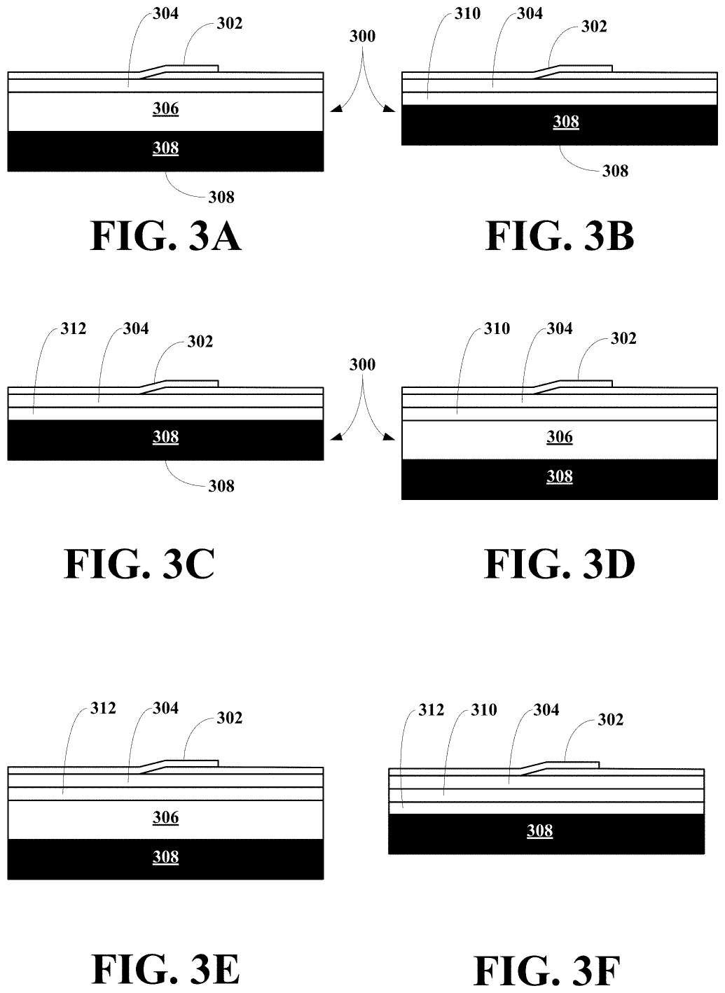

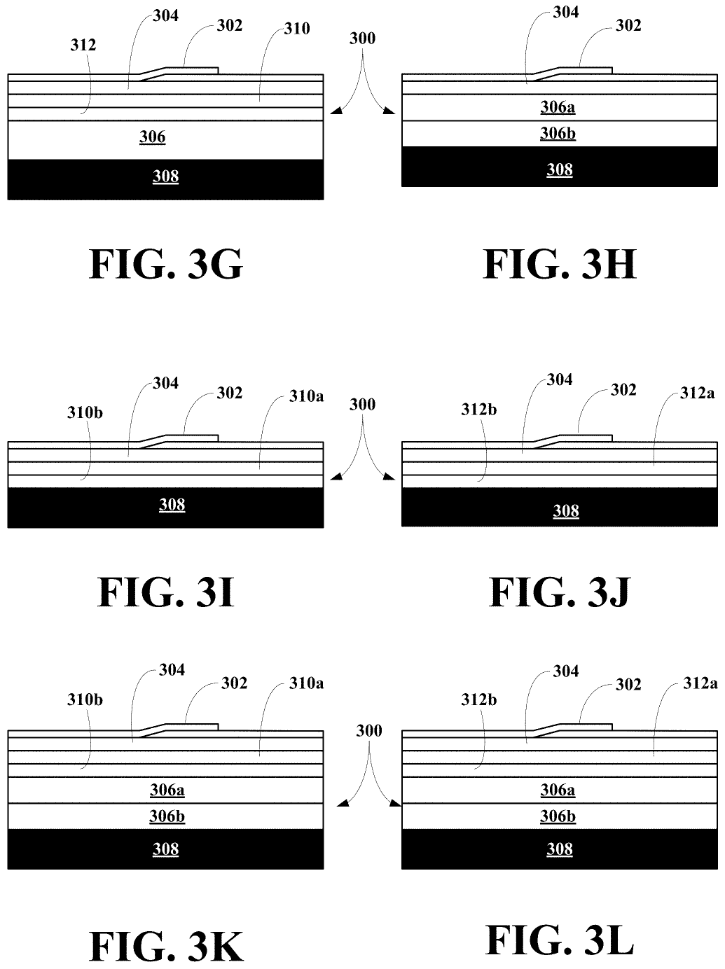

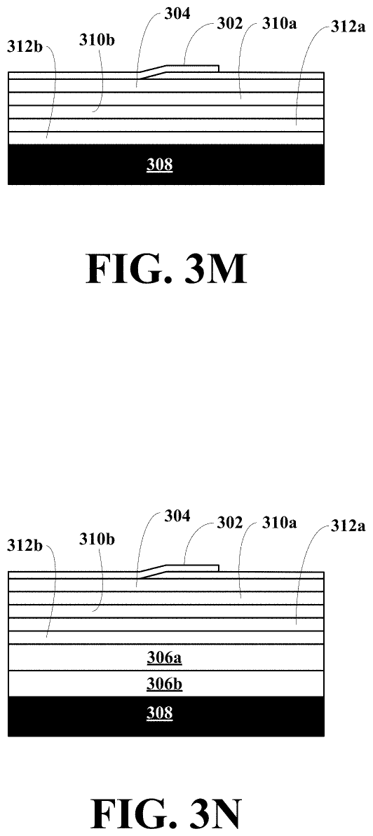

Referring now to FIGS. 3A-N, embodiments of non-slip paw layered constructs, articles, or apparatuses, generally 300, are shown. Looking at FIG. 3A, an embodiment of the constructs, articles, or apparatuses 300 is shown to include a release sheet 302, an adhesive layer 304, a shock absorbent layer 306, and a non-slip layer 308. Looking at FIG. 3B, another embodiment of the constructs, articles, or apparatuses 300 is shown to include the release sheet 302, the adhesive layer 304, a medicated layer 310, and the non-slip layer 308. Looking at FIG. 3C, another embodiment of the constructs, articles, or apparatuses 300 is shown to include the release sheet 302, the adhesive layer 304, a thermal insulating layer 312, and the non-slip layer 308.

Looking at FIG. 3D, another embodiment of the constructs, articles, or apparatuses 300 is shown to include the release sheet 302, the adhesive layer 304, the medicated layer 310, the shock absorbent layer 306, and the non-slip layer 308. Looking at FIG. 3E, another embodiment of the constructs, articles, or apparatuses 300 is shown to include the release sheet 302, the adhesive layer 304, the thermal insulating layer 312, the shock absorbent layer 306, and the non-slip layer 308. Looking at FIG. 3F, another embodiment of the constructs, articles, or apparatuses 300 is shown to include the release sheet 302, the adhesive layer 304, the medicated layer 310, the thermal insulating layer 312, and the non-slip layer 308. Looking at FIG. 3G, another embodiment of the constructs, articles, or apparatuses 300 is shown to include the release sheet 302, the adhesive layer 304, the medicated layer 310, the thermal insulating layer 312, the shock absorbent layer 306, and the non-slip layer 308.

Looking at FIG. 3H, another embodiment of the constructs, articles, or apparatuses 300 is shown to include the release sheet 302, the adhesive layer 304, a first shock absorbent layer 306a, a second shock absorbent layer 306b, and the non-slip layer 308. Looking at FIG. 3I, another embodiment of the constructs, articles, or apparatuses 300 is shown to include the release sheet 302, the adhesive layer 304, a first medicated layer 310a, a second medicated layer 310b, and the non-slip layer 308. Looking at FIG. 3J, another embodiment of the constructs, articles, or apparatuses 300 is shown to include the release sheet 302, the adhesive layer 304, a first medicated layer 312a, a second medicated layer 312b, and the non-slip layer 308.

FIG. 3K, another embodiment of the constructs, articles, or apparatuses 300 is shown to include the release sheet 302, the adhesive layer 304, the medicated layers 310a&b, the shock absorbent layers 306a&b, and the non-slip layer 308. FIG. 3L, another embodiment of the constructs, articles, or apparatuses 300 is shown to include the release sheet 302, the adhesive layer 304, the thermal insulating layers 312a&b, the shock absorbent layers 306a&b, and the non-slip layer 308. FIG. 3M, another embodiment of the constructs, articles, or apparatuses 300 is shown to include the release sheet 302, the adhesive layer 304, the medicated layers 310a&b, the thermal insulating layers 312a&b, and the non-slip layer 308. FIG. 3N, another embodiment of the constructs, articles, or apparatuses 300 is shown to include the release sheet 302, the adhesive layer 304, the medicated layers 310a&b, the thermal insulating layers 312a&b, the shock absorbent layers 306a&b, and the non-slip layer 308.

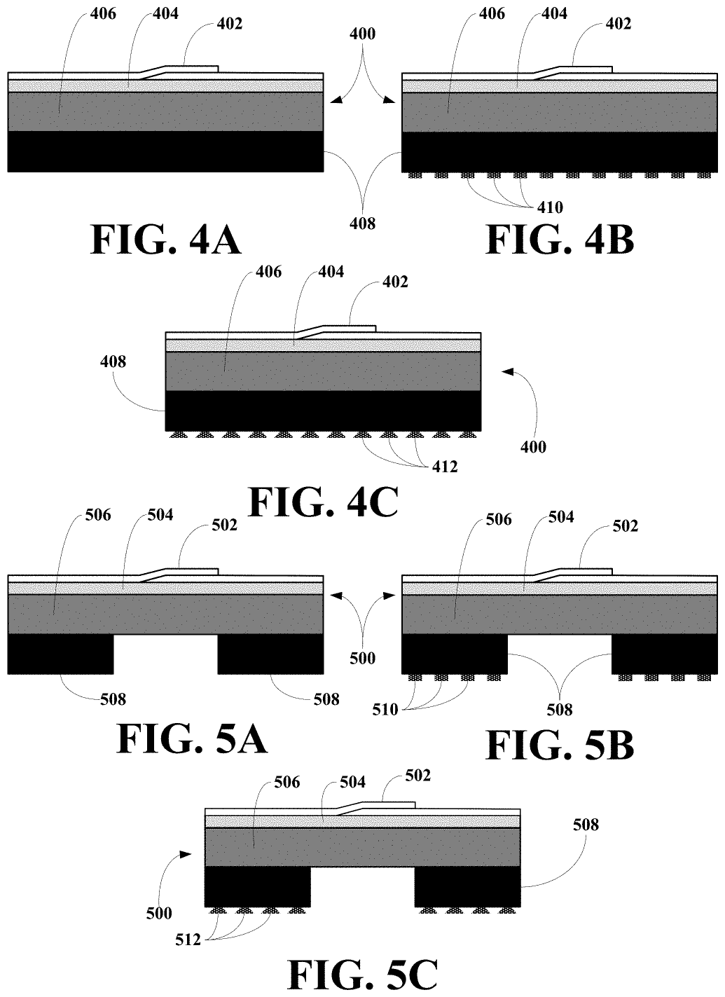

Referring now to FIGS. 4A-C, other embodiments of non-slip paw layered constructs, articles, or apparatuses, generally 400, are shown. Looking at FIG. 4A, an embodiment of the constructs, articles, or apparatuses 400 is shown to include a release sheet 402, an adhesive layer 404, a middle layer 406, and a non-slip layer 408. Looking at FIG. 4B, another embodiment of the constructs, articles, or apparatuses 400 is shown to include the release sheet 402, the adhesive layer 404, the middle layer 406, and the non-slip layer 408 including rectangular non-slips protrusions 410 comprising the same or different material as the non-slip layer 408. Looking at FIG. 4C, another embodiment of the constructs, articles, or apparatuses 400 is shown to include the release sheet 402, the adhesive layer 404, the middle layer 406, and the non-slip layer 408 including triangular non-slips protrusions 412 comprising the same or different material as the non-slip layer 408. The middle layer 406 in these embodiments may include one or more medicated layers, one or more shock absorbent layer, or combinations thereof.

Referring now to FIGS. 5A-C, other embodiments of non-slip paw layered constructs, articles, or apparatuses, generally 500, are shown. Looking at FIG. 5A, an embodiment of the constructs, articles, or apparatuses 500 is shown to include a release sheet 502, an adhesive layer 504, a middle layer 506, and a non-slip layer 508, which may comprise two members or a shell. Looking at FIG. 5B, another embodiment of the constructs, articles, or apparatuses 500 is shown to include the release sheet 502, the adhesive layer 504, the middle layer 506, and the non-slip layer 508 including rectangular non-slips protrusions 510 comprising the same or different material as the non-slip layer 508. Looking at FIG. 5C, another embodiment of the constructs, articles, or apparatuses 500 is shown to include the release sheet 502, the adhesive layer 504, the middle layer 506, and the non-slip layer 508 including triangular non-slips protrusions 512 comprising the same or different material as the non-slip layer 508. The middle layer 506 in these embodiments may include one or more medicated layers, one or more shock absorbent layer, or combinations thereof

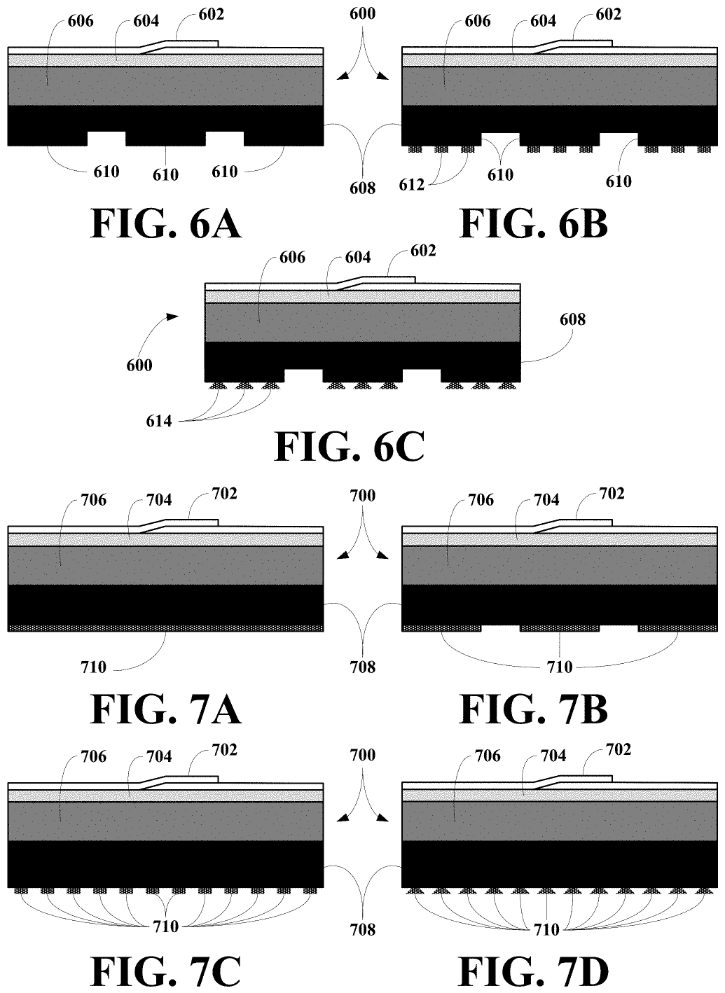

Referring now to FIGS. 6A-C, other embodiments of non-slip paw layered constructs, articles, or apparatuses, generally 600, are shown. Looking at FIG. 6A, an embodiment of the constructs, articles, or apparatuses 600 is shown to include a release sheet 602, an adhesive layer 604, a middle layer 606, and a non-slip layer 608 including steps or shells 610. Looking at FIG. 6B, another embodiment of the constructs, articles, or apparatuses 600 is shown to include the release sheet 602, the adhesive layer 604, the middle layer 606, and the non-slip layer 608 including steps or shells 610 having rectangular protrusions 612, wherein the steps or shells 610 and the protrusions 612 comprise the same or different material as the non-slip layer 608. Looking at FIG. 6C, another embodiment of the constructs, articles, or apparatuses 600 is shown to include the release sheet 602, the adhesive layer 604, the middle layer 606, and the non-slip layer 608 including steps or shells 610 having triangular protrusions 614, wherein the steps or shells 610 and the protrusions 614 comprise the same or different material as the non-slip layer 608. The middle layer 606 in these embodiments may include one or more medicated layers, one or more shock absorbent layer, or combinations thereof.

Referring now to FIGS. 7A-D, other embodiments of non-slip paw layered constructs, articles, or apparatuses, generally 700, are shown. Looking at FIG. 7A, an embodiment of the constructs, articles, or apparatuses 700 is shown to include a release sheet 702, an adhesive layer 704, a middle layer 706, a first non-slip layer 708, and a second non-slip layer 710, wherein the two non-slip layers 708 and 710 may comprise the same or different non-slip materials. Looking at FIG. 7B, another embodiment of the constructs, articles, or apparatuses 700 is shown to include the release sheet 702, the adhesive layer 704, the middle layer 706, the first non-slip layer 708 and the second non-slip layer 710, wherein the second non-slip layer 710 comprises steps or shells and wherein the two non-slip layers 708 and 710 may comprise the same or different non-slip materials. Looking at FIG. 7C, another embodiment of the constructs, articles, or apparatuses 700 is shown to include the release sheet 702, the adhesive layer 704, the middle layer 706, the first non-slip layer 708, and the second non-slip layer 710, wherein the second non-slip layer 710 comprises rectangular protrusions 712, wherein the two non-slip layers 708 and 710 may comprise the same or different non-slip materials. Looking at FIG. 7D, another embodiment of the constructs, articles, or apparatuses 700 is shown to include the release sheet 702, the adhesive layer 704, the middle layer 706, the first non-slip layer 708, and the second non-slip layer 710, wherein the second non-slip layer 710 comprises triangular protrusions 714, wherein the two non-slip layers 708 and 710 may comprise the same or different non-slip materials. The middle layer 706 in these embodiments may include one or more medicated layers, one or more shock absorbent layer, or combinations thereof.

### Toe Pad Outer Surface Configurations

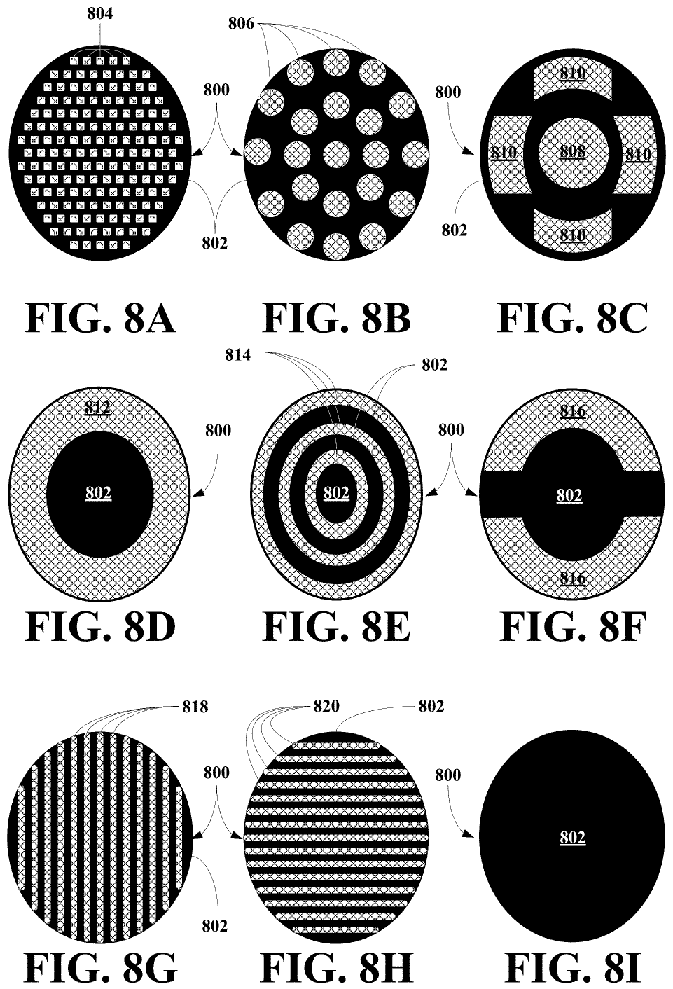

Referring now to FIGS. 8A-I, embodiments of the outer pad surface layers, generally 800, are shown. Looking at FIG. 8A, an embodiment of the outer pad surface layer 800 including a non-slip layer 802 including rectangular protrusions 804 arranged in matrix configuration, wherein the non-slip layer 802 and the protrusions 804 may be made of the same or different non-slip material. It should be recognized that the rectangular protrusions 804 may be arranged in an offset or staggered matrix configuration or any other desired configuration. Looking at FIG. 8B, another embodiment of the outer pad surface layer 800 including the non-slip layer 802 having circular protrusions 806 arranged in a concentric configuration, wherein the non-slip layer 802 and the protrusions 806 may be made of the same or different non-slip material. It should be recognized that the circular protrusions 806 may be arranged in any desired configuration. Looking at FIG. 8C, another embodiment of the outer pad surface layer 800 including the non-slip layer 802 having a circular middle protrusion 808 and four curved rectangular protrusions 810 arranged in a concentric configuration, but any other configuration may be used. It should be recognized that the protrusions 808 and 810 may be made of the same or different non-slip material. Looking at FIG. 8D, another embodiment of the outer pad surface layer 800 including the non-slip layer 802 having a a shell protrusion 812. It should be recognized that the non-slip layer 802 and the shell protrusion 812 may be made of the same or different non-slip material. Looking at FIG. 8E, another embodiment of the outer pad surface layer 800 including the non-slip layer 802 having a plurality of shell protrusions 814 arranged in a concentric configuration. It should be recognized that the non-slip layer 802 and the shell protrusions 814 may be made of the same or different non-slip material. Looking at FIG. 8F, another embodiment of the outer pad surface layer 800 including the non-slip layer 802 having U-shaped protrusions 816. It should be recognized that the non-slip layer 802 and the U-shaped protrusions 816 may be made of the same or different non-slip material. Looking at FIG. 8G, another embodiment of the outer pad surface layer 800 including the non-slip layer 802 having vertical strip protrusions 818. It should be recognized that the non-slip layer 802 and the vertical strip protrusions 818 may be made of the same or different non-slip material. Looking at FIG. 8H, another embodiment of the outer pad surface layer 800 including the non-slip layer 802 having horizontal strip protrusions 820. It should be recognized that the non-slip layer 802 and the horizontal strip protrusions 820 may be made of the same or different non-slip material. Looking at FIG. 8I, another embodiment of the outer pad surface layer 800 including the non-slip layer 802, with no protrusions.

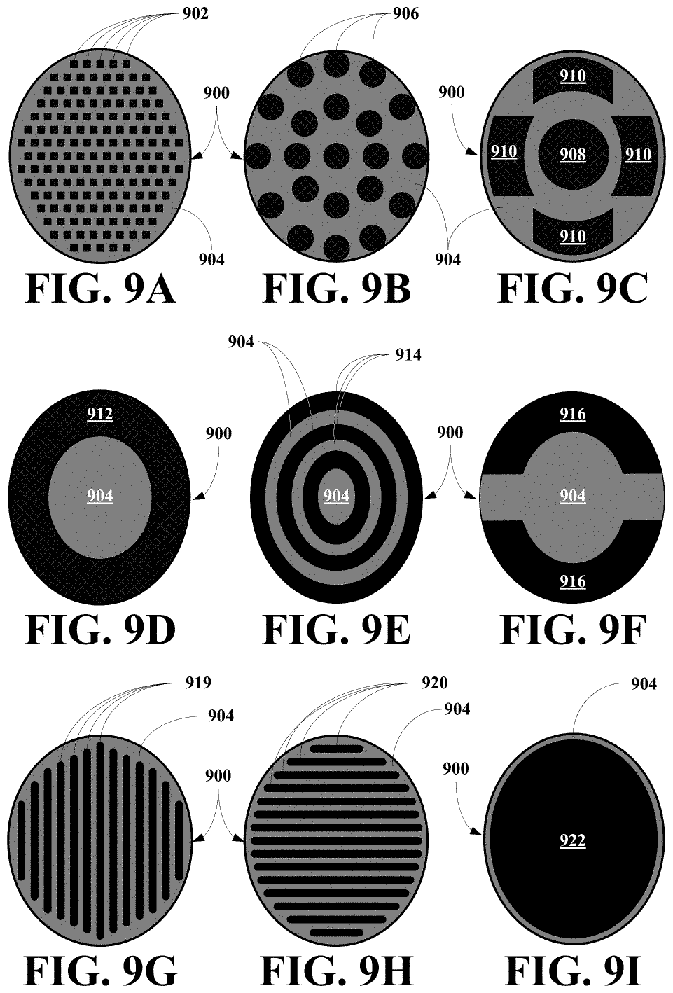

Referring now to FIGS. 9A-I, embodiments of the outer pad surface layers, generally 900, are shown. Looking at FIG. 9A, an embodiment of the outer pad surface layer 900 including non-slip rectangular members 902 arranged in matrix configuration on top a middle layer 904. It should be recognized that the rectangular members 902 may be arranged in an offset or staggered matrix configuration or any other desired configuration. Looking at FIG. 9B, another embodiment of the outer pad surface layer 900 including the middle layer 904 and non-slip circular members 906 arranged in a concentric configuration, wherein the non-slip layer 902 and the members 906 may be made of the same or different non-slip material. It should be recognized that the circular members 906 may be arranged in any desired configuration. Looking at FIG. 9C, another embodiment of the outer pad surface layer 900 including the middle layer 904 and a non-slip circular middle member 908 and four non-slip curved rectangular members 910 arranged in a concentric configuration, but any other configuration may be used. It should be recognized that the members 908 and 910 may be made of the same or different non-slip material. Looking at FIG. 9D, another embodiment of the outer pad surface layer 900 including the middle layer 904 and a non-slip shell member 912. Looking at FIG. 9E, another embodiment of the outer pad surface layer 900 including the middle layer 904 and a plurality of non-slip shell members 914 arranged in a concentric configuration. It should be recognized that each of the non-slip shell members 914 may be made of the same or different non-slip material. Looking at FIG. 9F, another embodiment of the outer pad surface layer 900 including the middle layer 904 and U-shaped members 916. It should be recognized that each of the U-shaped members 916 may be made of the same or different non-slip material. Looking at FIG. 9G, another embodiment of the outer pad surface layer 900 including the middle layer 904 and vertical strip members 918. It should be recognized that each of the vertical strip members 918 may be made of the same or different non-slip material. Looking at FIG. 9H, another embodiment of the outer pad surface layer 900 including the middle layer 904 and horizontal strip members 920. It should be recognized that each of the horizontal strip members 920 may be made of the same or different non-slip material. Looking at FIG. 9I, another embodiment of the outer pad surface layer 900 including the middle layer 904 and a solid non-slip layer 922. The middle layer 904 in these embodiments may include one or more medicated layers, one or more shock absorbent layer, or combinations thereof.

### Metacarpal Pad Outer Surface Configurations

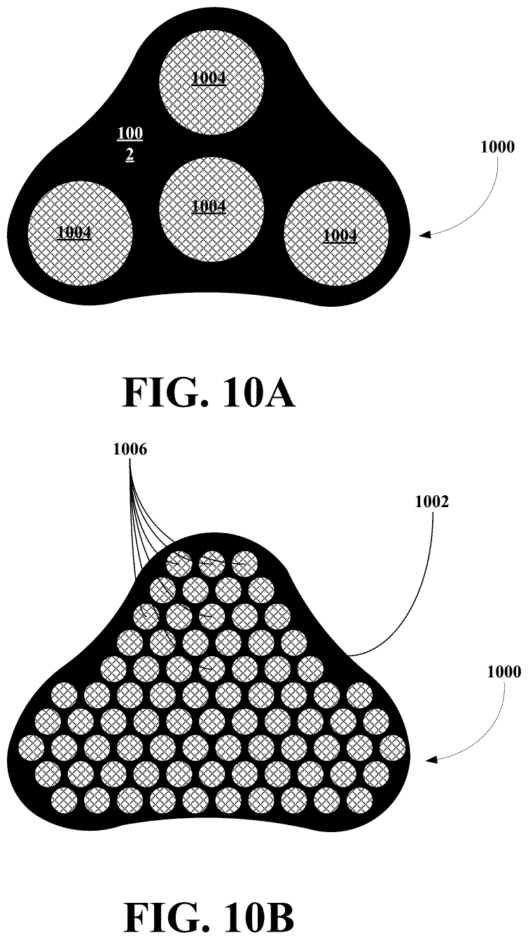

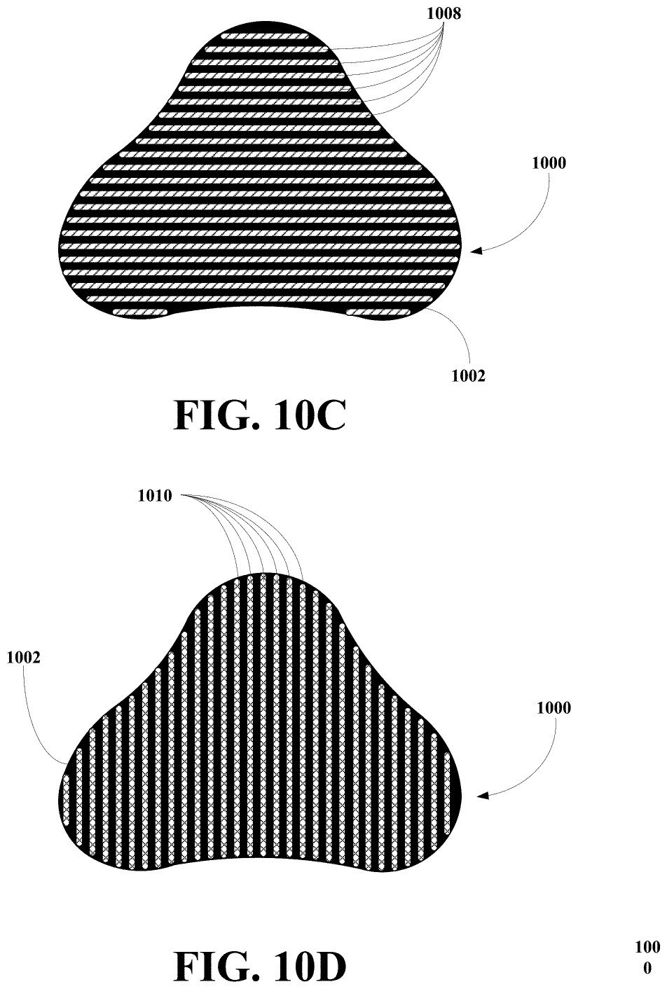

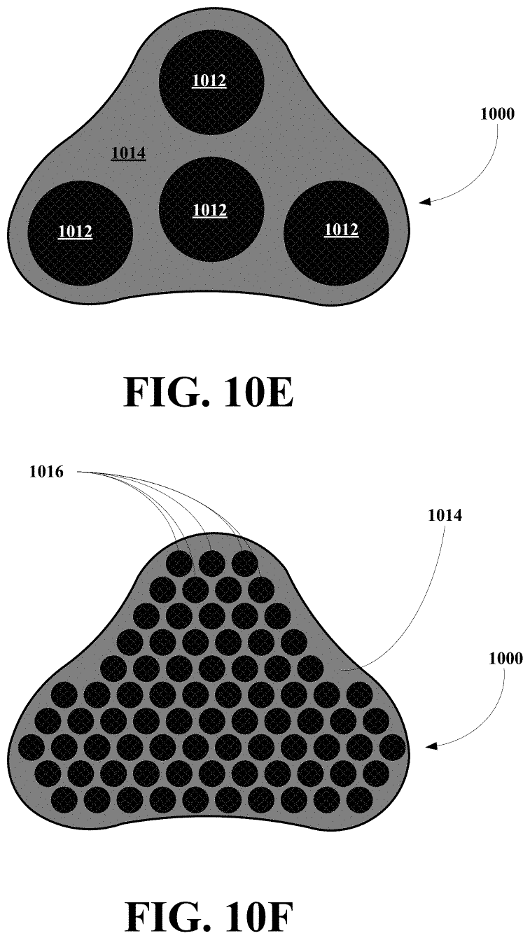

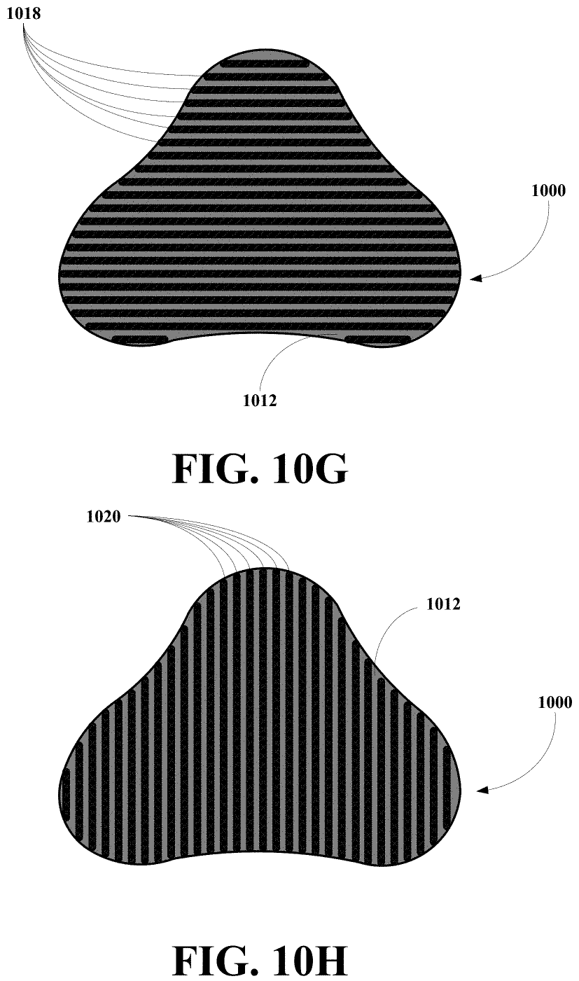

Referring now to FIGS. 10A-H, embodiments of non-slip metacarpal outer layers, generally 1000, are shown. Looking at FIG. 10A, an embodiment of the non-slip metacarpal outer layers 1000 is shown to include a non-slip layer 1002 including large circular protrusions 1004. It should be recognized that the large circular protrusions 1004 may be arranged in any desired configuration and maybe of any size or numbers and that the non-slip layer 1002 and the protrusions 1004 may be made of the same or different non-slip materials. Looking at FIG. 10B, another embodiment of the non-slip metacarpal outer layers 1000 is shown to include the non-slip layer 1002 and small circular protrusions 1006. It should be recognized that the small circular protrusions 1006 may be arranged in any desired configuration and may be of any size or numbers and that the non-slip layer 1002 and the protrusions 1006 may be made of the same or different non-slip materials. Looking at FIG. 10C, another embodiment of the non-slip metacarpal outer layers 1000 is shown to include the non-slip layer 1002 and horizontal non-slip protrusion strip members 1008. It should be recognized that the small circular protrusions 1008 may be arranged in any desired configuration and may be of any size or numbers and that the non-slip layer 1002 and the protrusions 1008 may be made of the same or different non-slip materials. Looking at FIG. 10D, another embodiment of the non-slip metacarpal outer layers 1000 is shown to include the non-slip layer 1002 and vertical non-slip protrusion strip members 1010. It should be recognized that the small circular protrusions 1010 may be arranged in any desired configuration and may be of any size or numbers and that the non-slip layer 1002 and the protrusions 1010 may be made of the same or different non-slip materials. Looking at FIG. 10E, another embodiment of the non-slip metacarpal outer layers 1000 is shown to include the non-slip large circular members 1012 arranged on top a middle layer 1014. It should be recognized that the large circular members 1012 may be arranged in any desired configuration and may be of any size or numbers and that the large circular members 1012 may be made of the same or different non-slip materials. Looking at FIG. 10F, another embodiment of the non-slip metacarpal outer layers 1000 is shown to include the non-slip small circular members 1016 arranged on top the middle layer 1014. It should be recognized that the small circular members 1016 may be arranged in any desired configuration and may be of any size or numbers and that the non-slip small circular members 1016 may be made of the same or different non-slip materials. Looking at FIG. 10G, another embodiment of the non-slip metacarpal outer layers 1000 is shown to include the non-slip horizontal strip members 1018 arranged on top the middle layer 1014. It should be recognized that the non-slip horizontal strip members 1018 may be arranged in any desired configuration and may be of any size or numbers and that the non-slip horizontal strip members 1018 may be made of the same or different non-slip materials. Looking at FIG. 10H, another embodiment of the non-slip metacarpal outer layers 1000 is shown to include the non-slip vertical strip members 1020 arranged on top the middle layer 1014. It should be recognized that the non-slip vertical strip members 1020 may be arranged in any desired configuration and may be of any size or numbers and that the non-slip vertical strip members 1020 may be made of the same or different non-slip materials.

### Double Sided Adhesive Apparatuses, Constructs, or Articles

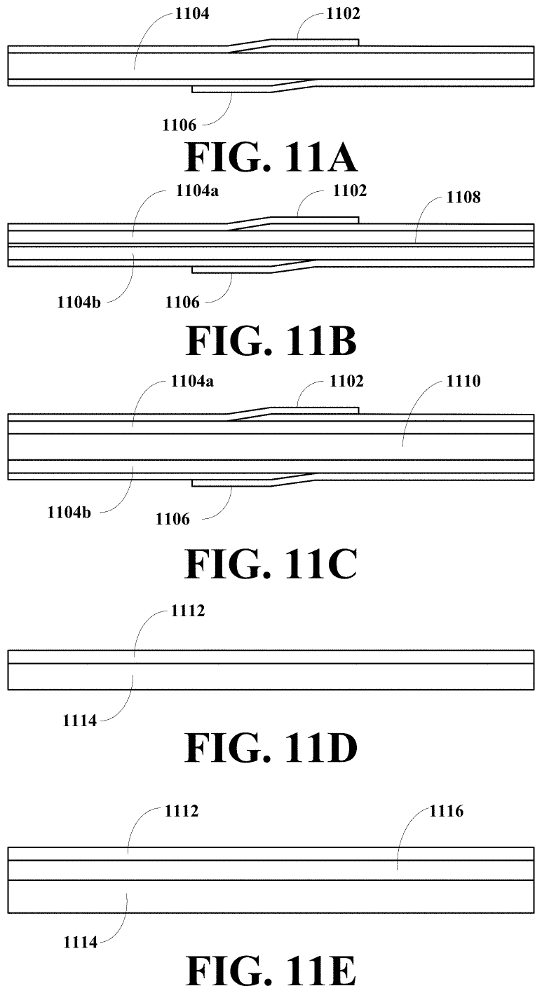

Referring now to FIGS. 11A-E, other embodiments of apparatuses, constructs, or articles, generally 1100, are shown. Looking at FIG. 11A, an embodiment of the apparatuses, constructs, or articles 1100 is shown to include a top release sheet 1102, an adhesive layer 1104, and a bottom release sheet 1106. Looking at FIG. 11B, an embodiment of the apparatuses, constructs, or articles 1100 is shown to include a top release sheet 1102, a top adhesive layer 1104a, a reinforcement layer 1108, a bottom adhesive layer 1104b and the bottom release sheet 1106. Looking at FIG. 11C, an embodiment of the apparatuses, constructs, or articles 1100 is shown to include a top release sheet 1102, a top adhesive layer 1104a, a shock absorption layer 1110, a bottom adhesive layer 1104b and the bottom release sheet 1106. Looking at FIG. 11D, an embodiment of the apparatuses, constructs, or articles 1100 is also shown to include an adhesive layer 1112 and a non-slip layer 1114. Looking at FIG. 11E, an embodiment of the apparatuses, constructs, or articles 1100 is shown to include the adhesive layer 1112, a shock absorption layer, a medicated layer, a thermal insulating layer or any combination thereof 1116 and the non-slip layer 1114.

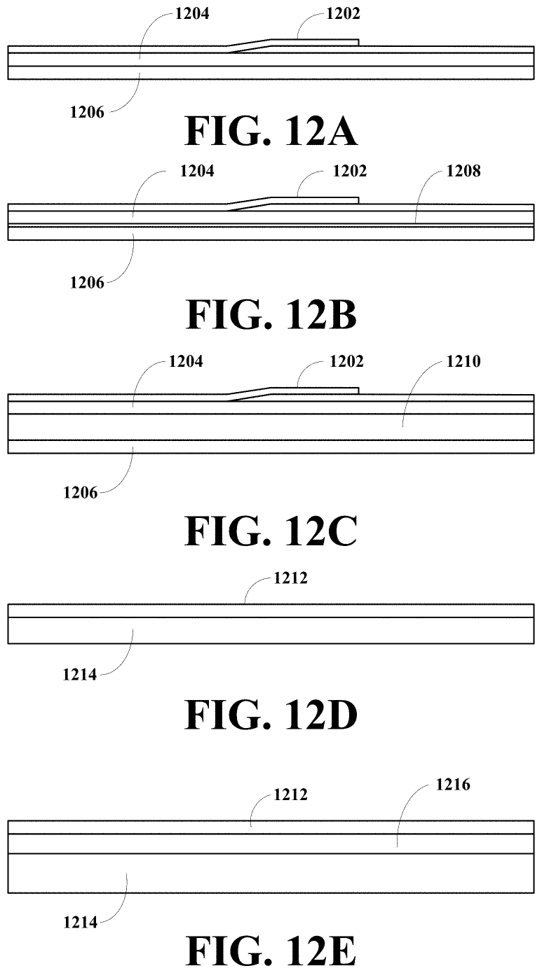

Referring now to FIGS. 12A-E, other embodiments of apparatuses, constructs, or articles, generally 1200, are shown. Looking at FIG. 12A, an embodiment of the apparatuses, constructs, or articles 1200 is shown to include a release sheet 1202, an adhesive layer 1204, and a bottom hook or loop layer 1206. Looking at FIG. 12B, an embodiment of the apparatuses, constructs, or articles 1200 is shown to include the release sheet 1202, the adhesive layer 1204, a reinforcement layer 1208, and the bottom hook or loop layer 1206. Looking at FIG. 12C, an embodiment of the apparatuses, constructs, or articles 1200 is shown to include the release sheet 1202, the adhesive layer 1204, a shock absorption layer 1210, and the bottom hook or loop layer 1206. Looking at FIG. 12D, an embodiment of the apparatuses, constructs, or articles 1200 is also shown to include a top look or hook layer 1212 and a non-slip layer 1214. Looking at FIG. 12E, an embodiment of the apparatuses, constructs, or articles 1200 is also shown to include the top loop or hook layer 1212, a shock absorption layer, a medicated layer, a thermal insulating layer or any combination thereof 1216 and the non-slip layer 1214.

### Apparatuses, Constructs, or Articles Including an Outer Layer Capable of Receiving a Spray on Non-Slip Coating

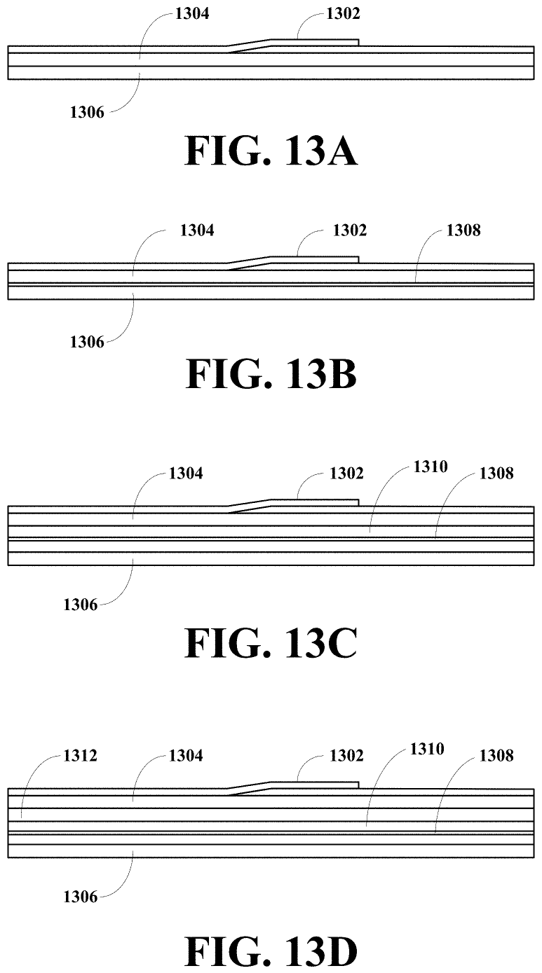

Referring now to FIGS. 13A-D, other embodiments of apparatuses, constructs, or articles, generally 1300, are shown. Looking at FIG. 13A, an embodiment of the apparatuses, constructs, or articles 1300 is shown to include a release sheet 1302, an adhesive layer 1304, and a bottom layer 1306. The bottom layer 1306 is designed to receive a spray on non-slip coating prior to applying the apparatus, construct or article to a digit or metacarpal of an animal's paw. The bottom layer 1306 may comprise an insulating material, a shock absorbing material, a medicated material, or any combination thereof, provided that a spray on non-slip material will adhere to the bottom layer. Looking at FIG. 13B, an embodiment of the apparatuses, constructs, or articles 1300 is shown to include the release sheet 1302, the adhesive layer 1304, a reinforcing layer 1308, and the bottom layer 1306, wherein the reinforcing layer 1308 may be a woven or non-woven fabric, aligned or random fibers, metal mesh, or any combination thereof. Again, the bottom layer 1306 may comprise an insulating material, a shock absorbing material, a medicated material, or any combination thereof. Looking at FIG. 13C, an embodiment of the apparatuses, constructs, or articles 1300 is shown to include the release sheet 1302, the adhesive layer 1304, a shock absorption layer 1310 optionally having the reinforcing layer 1308, and the bottom layer 1306. Looking at FIG. 13D, an embodiment of the apparatuses, constructs, or articles 1300 is shown to include the release sheet 1302, the adhesive layer 1304, an insulating layer 1312, the shock absorption layer 1310 optionally having the reinforcing layer 1308, and the bottom layer 1306.

For these embodiments, the disclosure provides a method for applying a non-slip surface to an animal's paw. The constructs of FIGS. 13A-D are unpacked from their packaging which may comprise the packaging generally used for band aid. Once removed with the bottom layer exposed, a spray can of non-slip rubber material is sprayed onto the bottom layer to produce a non-slip surface on the bottom layer. The thickness and properties of the non-slip surface is controlled by the consumer as to thickness, color, type, and texture. The non-slip spray may be any spray on elastomeric or rubber material provided that the material adheres to the bottom layer. Thus, the bottom layer comprises a material to which a spray on elastomeric or rubber material will adhere. Such material include smooth plastic materials, smooth elastomeric material, smooth insulating materials, smooth shock absorbing materials, smooth layers including medications, or any other type of smooth flexible surface on to which a spray on elastomeric or rubber material will adhere.

For these embodiments, the spray on elastomeric or rubber material may also be applied after the adhesive portion of the construct is placed on the pet. The spray on elastomeric or rubber material nozzle may be fitted with a tube to direct the elastomeric or rubber material more accurately. Additionally, the spray on elastomeric or rubber material may be applied to replace or renew the non-slip surface.

### Apparatuses, Constructs, or Articles Including One or More Pressure Switches

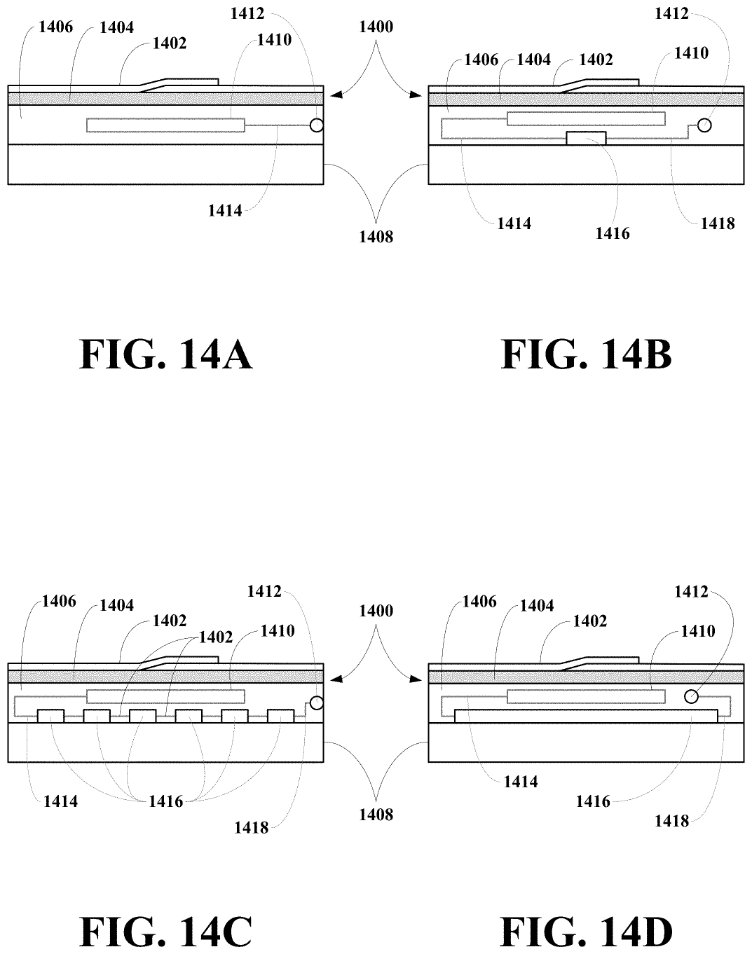

Referring now to FIGS. 14A-D, other embodiments of apparatuses, constructs, or articles, generally 1400, are shown.

Looking at FIG. 14A, an embodiment of the apparatuses, constructs, or articles 1400 is shown to include a release sheet 1402, an adhesive layer 1404, a middle layer 1406, and a bottom non-slip layer 1408. The middle layer 1406 includes an embedded battery 1410 and an embedded light emitting diode (LED) 1412 connected to the battery 1410 by electrical cable 1414.

Looking at FIG. 14B, an embodiment of the apparatuses, constructs, or articles 1400 is shown to include the release sheet 1402, the adhesive layer 1404, the middle layer 1406, and the bottom non-slip layer 1408. The middle layer 1406 includes the embedded battery 1410, an embedded pressure switch 1416, and the embedded LED 1412, wherein the switch 1416 is connected to the battery 1410 via the electrical cable 1414 and the LED 1412 is connected to the switch 1416 via an electrical cable 1418.

Looking at FIG. 14C, an embodiment of the apparatuses, constructs, or articles 1400 is shown to include the release sheet 1402, the adhesive layer 1404, a middle layer 1406, and the bottom non-slip layer 1406. The middle layer 1406 includes the embedded battery 1410, a plurality of embedded pressures switches 1416, and the embedded LED 1412, wherein the first switch 1416 is connected to the battery 1410 via the electrical cable 1414 and the LED 1412 is connected to the last switch 1416 via the electrical cable 1418 and each of the other switches 1416 are connected to each other via electrical cables 1420. The switches 1416 may be connected in series or parallel provided that once any one of the switches 1416 are triggered then the light will not be connected to the battery 1410.

Looking at FIG. 14D, an embodiment of the apparatuses, constructs, or articles 1400 is shown to include the release sheet 1402, the adhesive layer 1404, a middle layer 1406, and the bottom non-slip layer 1406. The middle layer 1406 includes the embedded battery 1410, an elongated pressures switch 1416, and the embedded LED 1412, wherein the switch 1416 is connected to the battery 1410 via the electrical cable 1414 and the LED 1412 is connected to the switch 1416 via the electrical cable 1418.

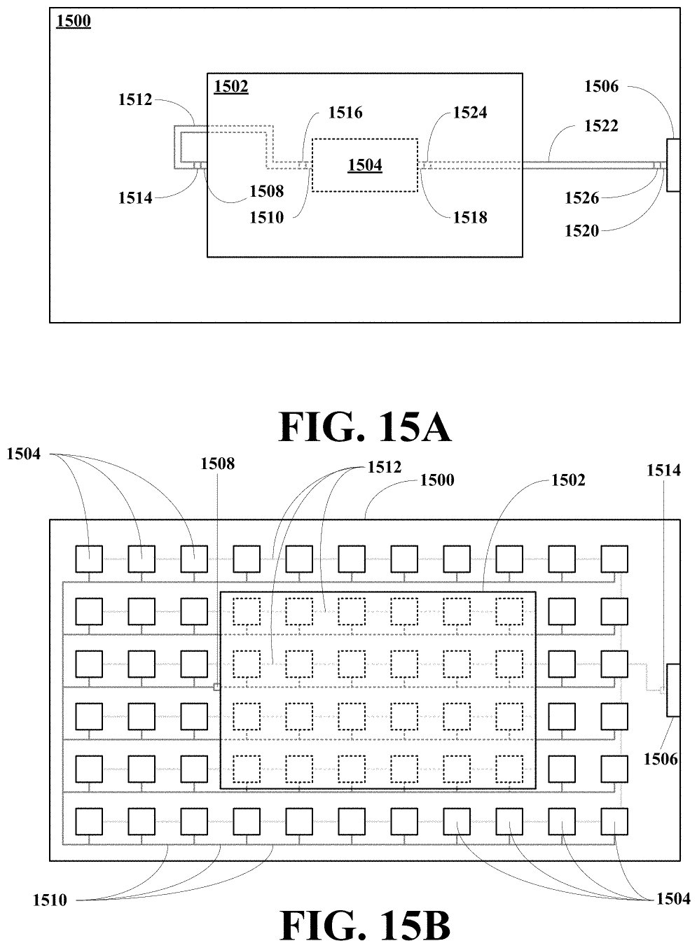

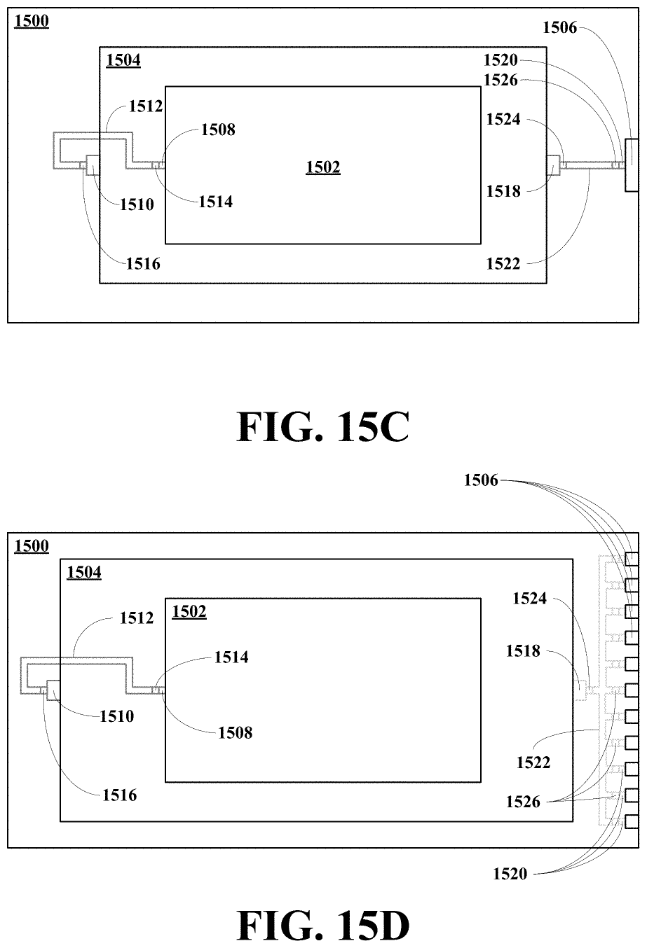

Referring now to FIGS. 15A-D, embodiments of the middle layer, generally 1500, are shown.

Looking at FIG. 15A, the middle layer 1500 is shown to include an embedded battery 1502, an embedded pressure switch 1504, and a light emitting diode (LED) 1506. The battery 1502 includes a battery connector 1508 and the switch 1504 includes a switch inlet connector 1510. The battery connector 1508 is connected to the switch inlet connector 1510 via an electrical cable 1512 including a proximal connector 1514 and a distal connector 1516. The switch 1504 includes a switch outlet connector 1518 and the LED 1506 include an LED connector 1520. The switch outlet connector 1514 is connected to the LED connector 1516 via an electrical cable 1522 including a proximal connector 1524 and a distal connector 1526. The switch 1504 is disposed below the battery 1502.

Looking at FIG. 15B, the middle layer 1500 is shown the embedded battery 1502, a plurality of embedded pressure switches 1504, and a light emitting diode (LED) 1506. The battery 1502 includes a battery connector 1508 connected to the switches 1504 via electrical cables 1510. The switches 1504 are connected in series via electrical cables 1512 and to an LED connector 1514.

Looking at FIG. 15C, the middle layer 1500 is shown to include the embedded battery 1502, a large embedded pressure switch 1504, and a light emitting diode (LED) 1506. The battery 1502 includes a battery connector 1508 and the switch 1504 includes a switch inlet connector 1510. The battery connector 1508 is connected to the switch inlet connector 1510 via an electrical cable 1512 having a proximal connector 1514 and a distal connector 1516. The switch 1504 also includes a switch outlet connector 1518 and the LED 1506 includes an LED connector 1520. The switch outlet connector 1518 is connected to the LED connector 1520 via an electrical cable 1522 having a proximal connector 1524 and a distal connector 1526.

Looking at FIG. 15D, the middle layer 1500 is shown to include the embedded battery 1502, the large embedded pressure switch 1504, and a plurality of the light emitting diodes (LEDs) 1506. The battery 1502 includes a battery connector 1508 and the switch 1504 includes a switch inlet connector 1510. The battery connector 1508 is connected to the switch inlet connector 1510 via an electrical cable 1512 having a proximal connector 1514 and a distal connector 1516. The switch 1504 also includes a switch outlet connector 1518 and the LEDs 1506 include LED connectors 1520. The switch outlet connector 1518 is connected to the LED connectors 1520 via an electrical cable 1522 having a proximal connector 1524 and distal connectors 1526.

In the embodiments of FIGS. 14A-D and FIGS. 15A-D, the middle layer may be opaque, translucent, clear, or combinations of opaque, translucent, and clear portions. In certain embodiments, the LED is disposed in the clear portions. In other embodiments, the LED is disposed at the distal edge of the middle layer. The location of the LED is so that they will be seen when the animal's paw is not in contact with the ground—that is the pressure switch stops the flow of electrical power to the LED or LEDs so that the LEDs emit light only when the animal's paw is not in contact with the ground. Generally, if the construct include more than one switch, then the switches are connected in series so that is any one is sensor pressure than no LED is lit.

### Closing Paragraph of the Disclosure

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

We claim:

1. A paw gripping composition comprising:
one or more resins, and/or
one or more polymers,
wherein the composition is formulated to adhere to an animal's paws and provide the paws with improve grip on slick surfaces.

2. The composition of claim 1, further comprising a carrier and/or one or more inert solids.

3. The composition of claim 1, further comprising one or more medications or veterinary pharmaceuticals for treating animal paws or animal diseases and/or infections provided that the medications or veterinary pharmaceutical may be absorbed through the paw, inner paw tissue, or neighboring tissues.

4. A paw gripping construct, article, or apparatus comprising:
four digit pads and a metacarpal pad, each of the pads including a release sheet, an adhesive layer adjacent the release sheet, at least one non-slip layer, and a middle layer interposed between the adhesive layer and the at least one non-slip layer,
wherein the middle layer includes one or more shock absorption layers, one or more medicated layers, one or more thermal insulating layers or any combination thereof.

5. The composition of claim 4, further comprising two packaging layers, with the pads configured on the lower packing layer with the outer non-slip layer in contact with the lower packaging layer and arranged on the low pin the conformity with a dog's paw.

6. The composition of claim 5, wherein each of the pads are separately packaged.

7. The composition of claim 5, wherein the outer non-slip layer of the pads are arranged on a weakly adhesive sheet in the configuration of a dog's paw, wherein the weakly adhesive sheet include an weakly adhesive.

8. The composition of claim 5, wherein the outer non-slip layer of each of the pads are arranged on a weakly adhesive sheet for maximum sheet coverage.

9. The composition of claim 5, further comprising a double sided adhesive strip for affixing to digits or a metacarpal of an animal's paw and then affixing to a non-slip constructs, articles, or apparatuses or an adhesive strip having a hook and loop layer, wherein the adhesive is for affixing the strip to the digits or a metacarpal of an animal's paw and the hook and loop layer is for affixing to a non-slip constructs, articles, or apparatuses including a loop and hook layer and a non-slip layer.

10. A methods comprising:
contacting one or more resins and/or one or more polymers and optionally one or more medications or veterinary pharmaceuticals for treating animal paws or animal diseases and/or infections provided that the medications or veterinary pharmaceuticals may be absorbed through the paw, inner paw tissue, or neighboring skin tissues, wherein the contacting occurs under conditions of time, temperature, pressure, mixing rate, and mixing type to form a homogeneous or substantially homogeneous gripping composition.

11. The method of claim 10, further comprising:
dissolving the medications or veterinary pharmaceuticals in an appropriate solvent and
applying the solution to the gripping composition under mixing conditions of time, temperature, pressure, mixing rate, and mixing type and then removing the solvent by any known means such as evaporation, vacuum evaporation, distillation, lyophilization, other freeze drying techniques, spray drying, air drying, oven drying, or any other solvent removing technique now known or yet invented.
